(19) United States
(12) Patent Application Publication
(10) Pub. No.: US 2018/0080403 A1
(43) Pub. Date: Mar. 22, 2018

(54) SYSTEM FOR CORRECTING ENGINE TORQUE AND METHOD OF CORRECTING ENGINE TORQUE

(71) Applicant: Hyundai Motor Company, Seoul (KR)

(72) Inventors: Dong Jun Shin, Hwaseong (KR); Jae Mun Lee, Seoul (KR); Chun Hyuk Lee, Suwon (KR)

(21) Appl. No.: 15/364,625

(22) Filed: Nov. 30, 2016

(30) Foreign Application Priority Data
Sep. 21, 2016 (KR) 10-2016-0120458

(51) Int. Cl. F02D 41/14; F02D 41/26; F02D 41/00

(52) U.S. Cl. CPC F02D 41/1402; F02D 41/26; F02D 41/0097; F02D 2250/18; F02D 2200/1002; F02D 2200/503; F02D 2200/0414

(57) ABSTRACT

A system for correcting engine torque includes: a torque correction value generator generating a torque correction value for correcting output torque of an engine; a torque correction determination unit determining applicability of the generated torque correction value; and a torque applying unit determining a final engine output torque by applying the generated torque correction value to the output torque of the engine based on the determined applicability of the generated torque correction value.

### CROSS-REFERENCE TO RELATED APPLICATION

This application claims priority to and the benefit of Korean Patent Application No. 10-2016-0120458, filed on Sep. 21, 2016 in the Korean Intellectual Property Office, the entire disclosure of which is incorporated herein by reference as if fully set forth herein.

### BACKGROUND OF THE DISCLOSURE

### 1. Technical Field

The present disclosure relates generally to a system for correcting engine torque and a method of correcting engine torque, and more particularly, to a system and method for correcting engine torque capable of improving fuel efficiency.

### 2. Description of the Related Art

In general, a target torque of an engine of a vehicle is determined in consideration of optimum system efficiency. More specifically, target torque of the engine is determined at an optimal operation line (OOL) of the engine within an engine efficiency map. In a hybrid electric vehicle, when the required torque for a driver is at low load, a high-voltage battery is charged by a difference between the target torque of the engine (determined by the OOL) and the required torque of the driver at low load, i.e., torque remaining after satisfying the required torque of the driver.

The efficiency map of the engine used to optimally determine target torque of the engine is mapped and provided through testing of a target engine at general room temperature. When air intake temperature of the engine is increased by an increase in temperature of external air or an increase in temperature of an engine room during driving, the engine efficiency changes due to a change in air density. As a result, when the change in air density is generated by an increase in temperature of the external air, the target torque of the engine (determined using the efficiency map of the engine mapped at room temperature) is not optimized, and proper correction of target torque of the engine is required.

Conventionally, deterioration of engine efficiency caused by an increase in intake temperature is recognized through a vehicle principle test, whereby an atmospheric pressure-intake temperature correction factor (AmpTia factor) used as an environmental factor in an engine management system (EMS) is introduced as a control factor to compensate target torque of the engine (determined based on the efficiency map of the engine mapped at room temperature). In detail, in a conventional hybrid electric vehicle, a compensation value for compensating the target torque of the engine based on the atmospheric pressure-intake temperature correction factor (AmpTia factor) and a state of charge (SoC) of a high-voltage battery is determined. The final target torque of the engine is determined by adding the compensation value to or subtracting the compensation value from the target torque of the engine.

However, the conventional correction method of target torque of the engine integrally compensates target torque in reference to the SoC of the high-voltage battery and the atmospheric pressure-intake temperature correction factor, regardless factors such as the revolutions-per-minute (RPM) of the engine, required torque of the driver, and gear of the vehicle. Consequently, torque compensation of the engine may be unnecessary, and torque compensation may decrease system efficiency.

### SUMMARY OF THE DISCLOSURE

Therefore, the present disclosure has been made in view of the above problems, and it is an object of the present disclosure to provide a system and method for correcting engine torque capable of improving efficiency and fuel efficiency by correction of engine torque, considering various driving states of a vehicle upon change in engine intake density.

In accordance with embodiments of the present disclosure, a system for correcting engine torque includes: a torque correction value generator generating a torque correction value for correcting output torque of an engine; a torque correction determination unit determining applicability of the generated torque correction value; and a torque applying unit determining a final engine output torque by applying the generated torque correction value to the output torque of the engine based on the determined applicability of the generated torque correction value.

The torque correction value generator may include: an intake density determination unit determining a factor related to intake density of the engine based on atmospheric pressure and intake temperature, and a torque correction map storing a torque correction value based on the factor related to a previous intake density of the engine and a previous state of charge of a main battery, receiving a factor related to a current intake density and a current state of charge of the main battery, and outputting the torque correction value.

The factor related to intake density may include an atmospheric pressure-intake temperature correction factor (AmpTia factor) which is used as an environmental factor of an engine management system (EMS).

The torque correction determination unit may determine whether the torque correction value is applied to the output torque of the engine based on at least one of the output torque of the present engine, revolutions-per-minute of the engine, a state of charge of a main battery, and part-load maximum torque of the engine.

The torque correction determination unit may include a state of charge determination unit receiving a state of charge of a main battery, comparing the state of charge of the main battery with a predetermined reference value, and applying the torque correction value when the state of charge of the main battery is greater than the predetermined reference value.

The torque correction determination unit may include a torque determination unit comparing the output torque of the engine with a predetermined reference value and applying the torque correction value when the output torque of the engine is greater than the predetermined reference value.

The torque correction determination unit may include an engine revolutions-per-minute determination unit comparing current revolutions-per-minute of the engine with a predetermined reference range and applying the torque correction value when the current revolutions-per-minute of the engine is within a predetermined reference range.

The torque correction determination unit may include a torque comparison unit comparing the output torque of the engine with part-load maximum torque and applying the torque correction value when a difference between the output torque of the engine and part-load maximum torque is less than a predetermined reference value.

The torque applying unit may include: a switching unit selectively outputting the generated torque correction value when the torque applying unit applies the torque correction value and selectively outputting zero when the torque applying unit does not apply the torque correction value, and a summing unit determining the final engine output torque by applying a value output at the switching unit to the output torque of the engine.

Furthermore, in accordance with embodiments of the present disclosure, a method of correcting engine torque includes: determining, by a controller, whether a driving environment of a vehicle necessitates torque correction; generating, by the controller, a torque correction value for correcting output torque of an engine when the driving environment necessitates torque correction; determining, by the controller, applicability of the generated torque correction value; and determining, by the controller, final engine output torque by applying the generated torque correction value to the output torque of the engine based on the determined applicability of the generated torque correction value.

The determining of whether the driving environment necessitates torque correction may include determining that the driving environment necessitates torque correction when an atmospheric pressure-intake temperature correction factor (AmpTia factor), which is used as an environmental factor in an engine management system (EMS), is greater than a predetermined reference value.

The method may further include applying the torque correction value when a state of charge of a main battery is greater than a predetermined reference value.

The method may further include applying the torque correction value when the output torque of the engine is greater than a predetermined reference value.

The method may further include applying the torque correction value when a revolutions-per-minute of the engine is within a predetermined reference range.

The method may further include: comparing the output torque of the engine with a part-load maximum torque; and applying the torque correction value when a difference between the output torque of the engine and the part-load maximum torque is less than a predetermined reference value.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating a system for correcting engine torque according to embodiments of the present disclosure;

FIG. 2 is a block diagram detailedly illustrating a torque correction value generator of the system for correcting engine torque according to embodiments of the present disclosure;

FIG. 3 is a block diagram detailedly illustrating a torque correction determination unit of the system for correcting engine torque according to embodiments of the present disclosure;

FIG. 4 is a view illustrating an engine efficiency map for setting a reference value applied to an the engine torque determination unit included in the torque correction determination unit of the system for correcting engine torque according to the embodiments of the present disclosure;

FIG. 5 is a view illustrating an engine efficiency map for setting a reference range applied to a revolutions-per-minute determination unit included in the torque correction determination unit of the system for correcting engine torque according to embodiments of the present disclosure;

FIG. 6 is a view illustrating an engine efficiency map for comparing torque applied to a torque comparison unit included in the torque correction determination unit of the system for correcting engine torque according to embodiments of the present disclosure; and

FIG. 7 is a view illustrating a method of correcting engine torque according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Hereinafter, a system for correcting engine torque and a method of correcting engine torque in accordance with embodiments of the present disclosure will be described with reference to the accompanying drawings.

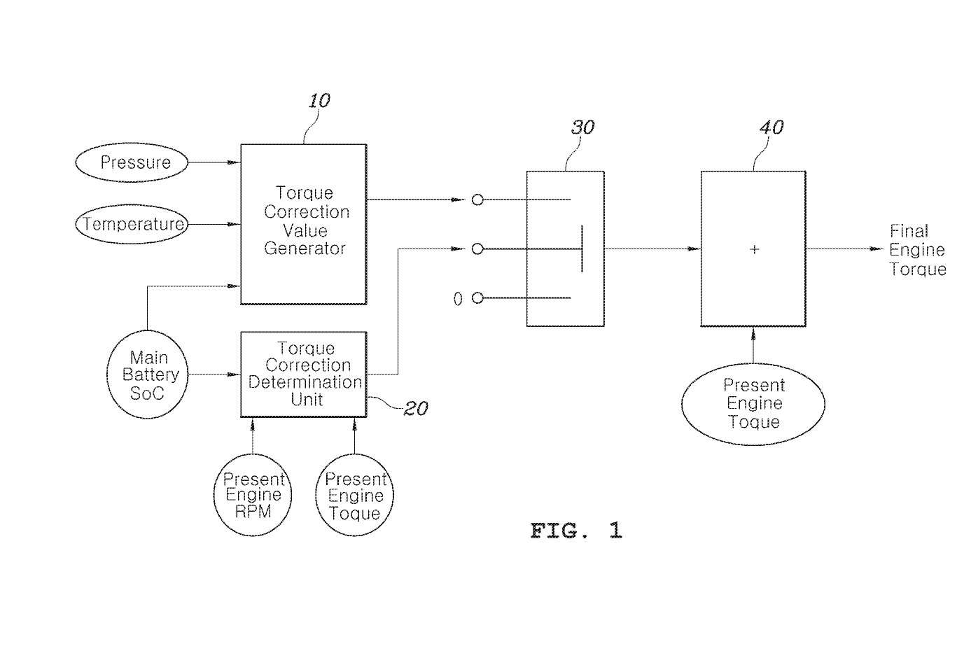

FIG. 1 is a block diagram illustrating a system for correcting engine torque according to embodiments of the present disclosure.

As shown in FIG. 1, the system for correcting engine torque according to embodiments of the present disclosure may include a torque correction value generator 10 generating a torque correction value for correcting output torque of an engine, a torque correction determination unit 20 determining applicability of the torque correction value, and a torque applying unit 30 and 40 applying the torque correction value to output torque of the present engine according to a determined result of the torque correction determination unit 20.

The torque correction value generator 10 generates the torque correction value based on intake density of the engine which is determined according to temperature and pressure of driving environment of the vehicle and a state of charge (SoC) of a main battery (e.g., a high-voltage battery) of a vehicle.

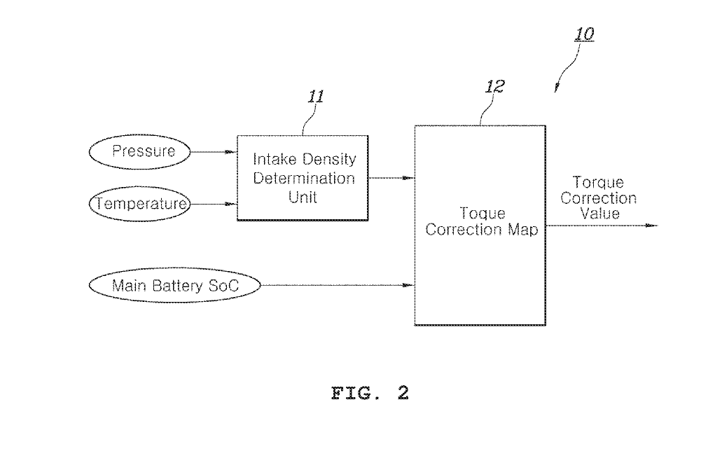

FIG. 2 is a block diagram detailedly illustrating a torque correction value generator of the system for correcting engine torque according to embodiments of the present disclosure.

As shown in FIG. 2, the torque correction value generator 10 of the system for correcting engine torque according to embodiments of the present disclosure may include an intake density determination unit 11 determining a factor related to intake density of the engine based on pressure and temperature of the driving environment of the vehicle and a torque correction map 12 inputting the state of charge of the main battery and the factor related to intake density output from intake density determination unit 11 to output the torque correction value corresponding thereto.

The intake density determination unit 11 may determine an atmospheric pressure-intake temperature correction factor (AmpTia factor) which is used as an environment factor in an engine management system (EMS) determined by deterioration tendency of engine efficiency according to increase in intake temperature and decrease in pressure through a vehicle principle test. That is, the factor related to intake density determined at intake density determination unit 11 may be the atmospheric pressure-intake temperature correction factor (AmpTia factor). The atmospheric pressure-intake temperature correction factor (AmpTia factor) is a factor determined by intake temperature and atmospheric pressure and is used to determine intake density. A detailed description of the atmospheric pressure-intake temperature correction factor (AmpTia factor) publicly known in the art is omitted.

The torque map 12 may determine the torque correction value of the engine based on the factor related to intake density which is determined at intake density determination unit 11 and the state of charge (SoC) of the main battery (not shown) storing power supplied to a motor of a hybrid electric vehicle. The torque map 12 may be a two-dimensional map predetermining and storing the torque correction value according to the factor related to intake density and the state of charge of the main battery through a preliminary test.

Conventionally, the torque correction value generated at the torque correction value generator 10 is used to determine engine torque without conditions. Accordingly, in the conventional case, a problem may arise involving usage of the torque correction value in the case that the torque correction value is not required, in the case that the torque correction value is applied, or in the case that engine efficiency decreases.

Thus, according to embodiments of the present disclosure, the torque correction determination unit 20 is provided to determine applicability of the torque correction value generated at the torque correction value generator 10, considering various conditions.

The torque correction determination unit 20 may determine applicability of the torque correction value generated at the torque correction value generator 10 considering at least one of output torque of the present engine, revolutions-per-minute (RPM) of the present engine, the state of charge of the main battery, and part-load maximum torque of the present engine.

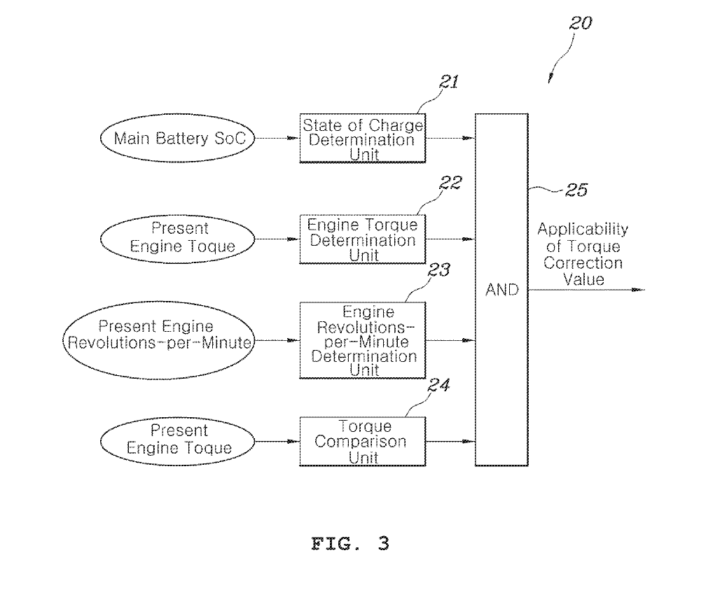

FIG. 3 is a block diagram detailedly illustrating a torque correction determination unit of the system for correcting engine torque according to embodiments of the present disclosure.

As shown in FIG. 3, according to embodiments of the present disclosure, the torque correction determination unit 30 of the system for correcting engine torque used as a component for determining applicability of the torque correction value may include a state of charge determination unit 21, the engine torque determination unit 22, an engine revolutions-per-minute determination unit 23, and a torque comparison unit 24. Furthermore, the torque correction determination unit 30 may further include an output unit 25 determining and outputting applicability of the torque correction value based on signals output by the state of charge determination unit 21, the engine torque determination unit 22, the engine revolutions-per-minute determination unit 23, and the torque comparison unit 24.

In FIG. 3, the state of charge determination unit 21, the engine torque determination unit 22, the engine revolutions-per-minute determination unit 23, and the torque comparison unit 24 are illustrated as components for determining applicability of the torque correction value but these are merely examples and a part thereof may be omitted. Furthermore, as illustrated in FIG. 3, the output unit 25 performs interaction logic AND operation with the output signals of the state of charge determination unit 21, the engine torque determination unit 22, the engine revolutions-per-minute determination unit 23, and the torque comparison unit 24 to output a result thereof. However, this is just an example and applicability of a final torque correction value may be determined by other methods.

The state of charge determination unit 21 may receive the state of charge (SoC) of the main battery to compare the state of charge (SoC) of the main battery with a predetermined reference value. When the state of charge of the main battery is greater than the reference value, the state of charge determination unit 21 may determine to apply an engine torque correction value.

The state of charge of the general main battery may be classified into a high state of charge region, a normal state of charge region, and a low state of charge region. The high state of charge is a high level of the state of charge of the main battery to induce discharge such that the high state of charge region is a region where control of restore to the normal state of charge is required. The normal state of charge is a normal range of the state of charge of the main battery, namely, an optimally controllable region of the system, such that the normal state of charge region is a region where control of maintenance of the normal state of charge. Furthermore, the low state of charge is a low level of the state of charge of the main battery to prevent depletion of the state of charge through maximum charge control and to control to restore the normal state of charge.

When the state of charge of the present main battery is in the region more than the normal state of charge region of the regions determining the states of charge of the main battery as described above, the state of charge determination unit 21 may determine to apply of the torque correction value. When the surrounding environment of the engine is in a deteriorated state (e.g., in the state that intake temperature is increased thus decreasing intake density) and in the case of decrease in output and efficiency of the engine in comparison with room temperature, the engine efficiency is compensated by decrease in torque command according to various embodiments of the present disclosure. Accordingly, the state of charge determination unit 21 allows engine torque to be decreased based on torque command compensation such that the charge of the battery may be decreased. Thereby, the torque correction value may be applied at the region above the normal state of charge region which is easily capable of managing the state of charge of the battery.

Then, the engine torque determination unit 22 compares the present engine output torque with a predetermined reference value. When the present engine output torque is greater than the predetermined reference value, the engine torque determination unit 22 may determine to apply the torque correction value. When the present engine output torque is less than the predetermined reference value, the engine torque determination unit 22 may determine not to apply the torque correction value.

The determination method of the engine torque determination unit 22 may be clearly understood referring to an efficiency map of the engine.

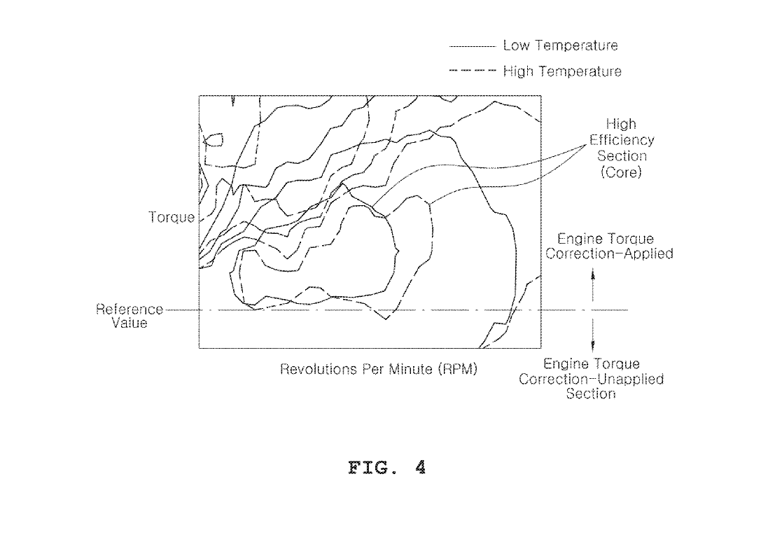

FIG. 4 is a view illustrating an engine efficiency map for setting a reference value applied to an the engine torque determination unit included in the torque correction determination unit of the system for correcting engine torque according to embodiments of the present disclosure.

In FIG. 4, a horizontal axis of the efficiency map of the engine indicates a revolutions-per-minute (RPM) of the engine and a vertical axis indicates torque of the engine. A solid line indicates brake specific fuel consumption (BSFC) of the engine at low intake temperature. A dotted line indicates brake specific fuel consumption of the engine at high intake temperature. The brake specific fuel consumption indicates the fuel amount required to output 1 kW of power of the engine while the brake specific fuel consumption means the engine efficiency. That is, FIG. 4 illustrates the engine efficiency according to the revolutions-per-minute and torque of the engine. Curved lines formed by the solid line and the dotted line which indicate the brake specific fuel consumption respectively have a contour shape, and the efficiency is increased toward a center of the contour.

Referring to the engine efficiency map as illustrated in FIG. 4, for effective management of the engine, the engine operation may be controlled that the engine performed at an adjacent portion of the center (i.e., core) of the curved line indicating the brake specific fuel consumption. However, as illustrated in FIG. 4, a region below a certain value of engine torque is a lower part of the core of the curved line indicating the brake specific fuel consumption while being a section where the brake specific fuel consumption is not largely changed according to temperature. Namely, the lower part of the core is a stationary section of engine efficiency despite change of intake density. Thus, the reference value compared with output torque of the engine in the engine torque determination unit 22 may be determined as a value defining a region corresponding to the lower part of the core of the curved line indicating the brake specific fuel consumption.

In addition, the revolutions-per-minute determination unit 23 compares the revolutions-per-minute of the present engine with a predetermined reference range. When the revolutions-per-minute of the present engine is within the predetermined reference range, the revolutions-per-minute determination unit 23 may determine to apply the torque correction value. When the revolutions-per-minute of the present engine is outside the predetermined reference range, the revolutions-per-minute determination unit 23 may determine not to apply the torque correction value.

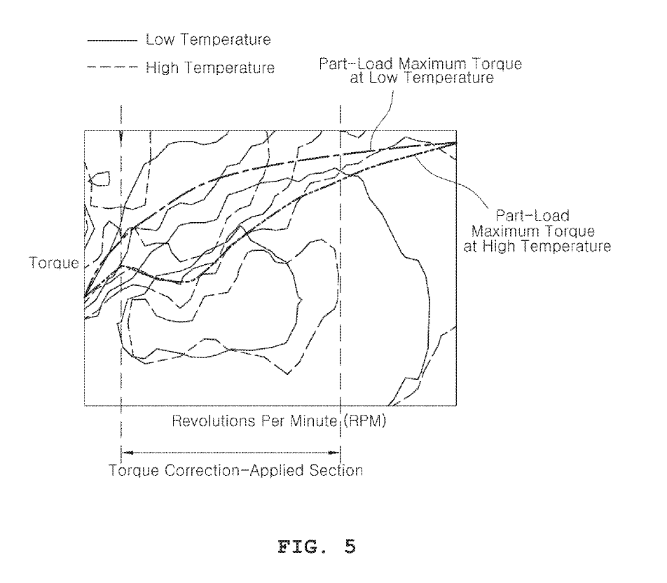

FIG. 5 is a view illustrating an engine efficiency map for setting a reference range applied to a revolutions-per-minute determination unit included in the torque correction determination unit of the system for correcting engine torque according to embodiments of the present disclosure.

FIG. 5 illustrates an engine efficiency map similar to FIG. 4. Particularly, an alternate long and short dash line of FIG. 5 indicates part-load maximum torque at low temperature and an alternate long and two short dashes line in FIG. 5 indicates part-load maximum torque at high temperature.

Part-load maximum torque means maximum torque capable of being output at the revolutions-per-minute (RPM) of the currently active engine when the engine is in a part-load mode. The part-load mode is a mode maintaining theoretical air-fuel ratio while realizing torque capable of being output at the engine unlike a full-load mode realizing maximum torque of the engine maximally using the intake air quantity and the fuel quantity.

As illustrated in FIG. 5, when intake temperature becomes high, part-load maximum torque is decreased. An engine revolutions-per-minute section having high difference between part-load maximum torque at low intake temperature and part-load maximum torque at high intake temperature may determine a reference section.

Part-load maximum torque at low intake temperate and part-load maximum torque at high intake temperature may be calculated through the principle test on the corresponding engine in advance. Low intake temperature means external air temperature of around room temperature. High intake temperature means external air temperature having much higher temperature than room temperature. Part-load maximum torque at the low intake temperate and part-load maximum torque at high intake temperature may be properly determined to be measured at the principle test.

Lastly, the torque comparison unit 24 compares output torque of the present engine with part-load maximum torque. When difference between output torque of the present engine and part-load maximum torque is less than the predetermined reference value, the torque comparison unit 24 may determine to apply the torque correction value. When difference between output torque of the present engine and part-load maximum torque is greater than the predetermined reference value, the torque comparison unit 24 may determine not to apply the torque correction value. The torque comparison unit 24 may store part-load maximum torque determined through the test for the engine.

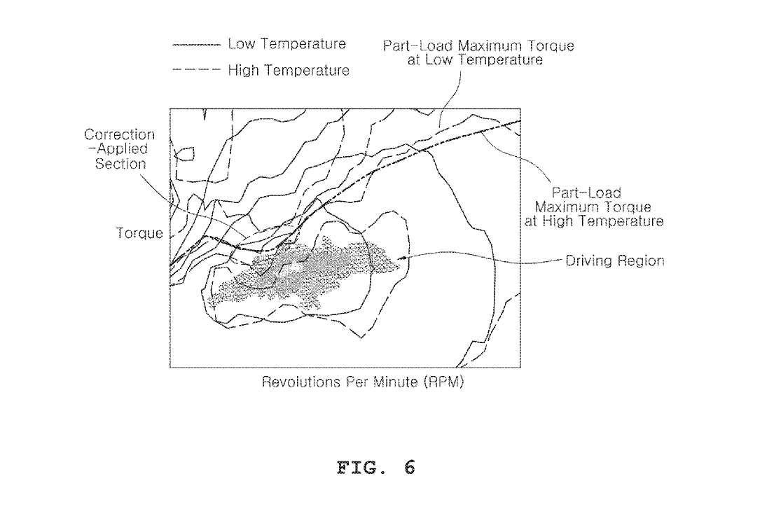

FIG. 6 is a view illustrating an engine efficiency map for comparing torque applied to a torque comparison unit included in the torque correction determination unit of the system for correcting engine torque according to embodiments of the present disclosure.

As illustrated in FIG. 6, the torque comparison unit 24 compares part-load maximum torque decreased due to increase in temperature with the present output torque. The torque comparison unit 24 compares difference between part-load maximum torque and the present output torque with a reference value to determine to apply the torque correction value. For example, when intake temperature increases and thus intake density decreases, part-load maximum torque of the engine decreases. Accordingly, the difference of a region, where the vehicle is driven, determined based on the brake specific fuel consumption on the engine efficiency map is decreased. Thus, when difference between part-load maximum torque of the engine and output torque of the present engine is less than the reference value, the torque comparison unit 24 may determine that intake density is decreased such that the torque comparison unit 24 may determine to apply the correction value.

The torque correction determination unit 20 according to embodiments of the present disclosure may determine applicability of the final correction value based on applicability of the correction values determined at the state of charge determination unit 21, the engine torque determination unit 22, the engine revolutions-per-minute determination unit 23, and the torque comparison unit 24. To this end, as illustrated above, the output unit 25 performing the logic AND operation is provided. When the state of charge determination unit 21, the engine torque determination unit 22, the engine revolutions-per-minute determination unit 23, and the torque comparison unit 24 all determine to apply the correction values, finally, the torque correction determination unit 20 may output a signal to perform application of the correction value. Alternatively, if at least one of the state of charge determination unit 21, the engine torque determination unit 22, the engine revolutions-per-minute determination unit 23, and the torque comparison unit 24 determines application of the correction value, the torque correction determination unit 20 may finally determine application of the correction value.

The torque applying unit 30 and 40 reflects applicability determined at the torque correction determination unit 20 to apply the torque correction value generated at the torque correction value generator 10 to output torque of the present engine, or to determine final engine torque without application of the torque correction value.

To this end, the torque applying unit 30 and 40 may include a selection switching unit 30 selectively outputting the torque correction value according to the determination result of the torque correction determination unit 20 and a summing unit 40 adding the value output by the selection switching unit 30 to output torque of the present engine to determine final engine torque.

The switching unit 30 may selectively output the torque correction value generated at the torque correction value generator 10 according to the determination result of the torque correction determination unit 20 or may selectively output zero (0). That is, when the torque correction determination unit 20 determines to perform torque correction, the switching unit 30 outputs the torque correction value generated at the torque correction value generator 10. When the torque correction determination unit 20 determines not to perform torque correction, the switching unit 30 outputs zero (0).

The summing unit 40 is a simple addition unit. The summing unit 40 determines final output torque by applying the value output at the switching unit 30 to output torque of the present engine.

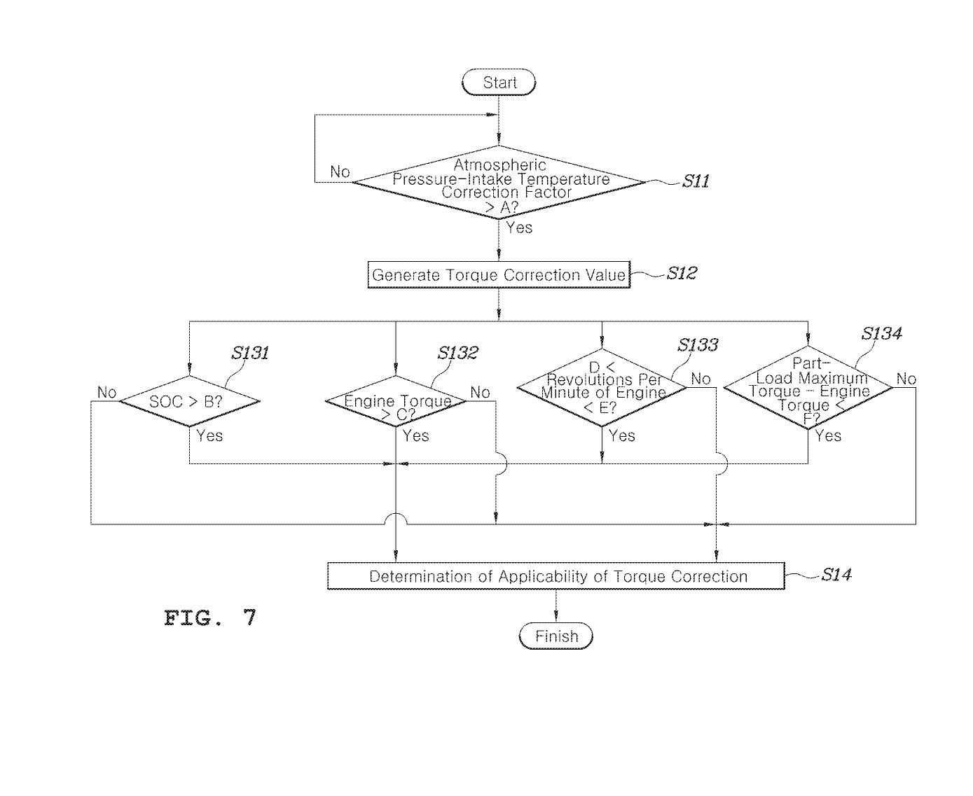

FIG. 7 is a view illustrating a method of correcting engine torque according to embodiments of the present disclosure. The method of correcting engine torque illustrated in FIG. 7 may be realized by operation of the system for correcting engine torque including the above-described configuration. Furthermore, calculation/determination performed by each component of the system for correcting engine torque according to the illustrated embodiment of the present disclosure and control of the entire system according to the calculation/determination may be performed by a controller or a plurality of controllers. In the following description, unless otherwise specified, it is publicly known that a specific calculation, determination, or control of operation may be performed by the controller, to those skilled in the art.

As shown in FIG. 7, the method of correcting engine torque according to embodiments of the present disclosure will be described. First, whether the driving environment of the vehicle requires torque correction or not is determined S11. For example, as intake density is lowered based on external temperature of the vehicle or atmospheric pressure, and intake temperature of the vehicle engine, engine output torque may be determined. In terms of determination of the vehicle engine, whether the correction value is applied or not may be determined. Particularly, the determination step S11 may be performed by the atmospheric pressure-intake temperature correction factor (AmpTia factor) determined at intake density determination unit 11 in the torque correction generator 10 generating the torque correction value. That is, when the atmospheric pressure-intake temperature correction factor (AmpTia factor) at intake density determination unit 11 is greater than a predetermined reference value A, it is determined that the environment requires correction of engine output torque S11. Then, a process of generation of the engine correction value and a process for determination of applicability of torque correction value according to engine torque, the revolutions-per-minute, or the state of charge of the main battery may be performed.

In step S11, when the atmospheric pressure-intake temperature correction factor (AmpTia factor) is greater that the predetermined reference value A, the torque correction value generator 10 inputs the factor related to intake density (the atmospheric pressure-intake temperature correction factor (AmpTia factor)) determined at intake density determination unit 11 and the state of charge (SoC) of the main battery (not shown) storing power supplied to the motor of the hybrid electric vehicle to determine the torque correction value of the engine according to the corresponding factor and the state of charge S12.

Sequentially, applicability of the torque correction value at each component of the torque correction determination unit 20 may be determined S131, S132, S133, and S134.

First, the state of charge determination unit 21 receives the SoC of the main battery to be compared with the predetermined reference value. When the state of charge of the main battery is greater than a reference value B, it may be determined that engine torque correction value is applied S131.

Furthermore, the engine torque determination unit 22 compares output torque of the present engine with the predetermined reference value. When output torque of the present engine is greater than a predetermined reference value C, the engine torque determination unit 22 may determine to apply the torque correction value, and when output torque of the present engine is less than the predetermined reference value C, the engine torque determination unit 22 may determine not to apply the torque correction value S132.

In addition, the engine revolutions-per-minute determination unit 23 compares the revolutions-per-minute (RPM) of the present engine with the predetermined reference range. When the RPM of the present engine is within the predetermined reference range D to E, the engine revolutions-per-minute determination unit 23 may determine to apply the torque correction value, and when the RPM of the present engine is outside the predetermined reference range D to E, the engine revolutions-per-minute determination unit 23 may determine not to apply the torque correction value S133.

Additionally, the torque comparison unit 24 compares output torque of the present engine with part-load maximum torque. When difference between output torque of the present engine and part-load maximum torque is less than a reference value F, the torque comparison unit 24 may determine to apply the torque correction value, and when difference between output torque of the present engine and part-load maximum torque is greater than the reference value F, the torque comparison unit 24 may determine not to apply the torque correction value S134.

Then, whether the torque correction value is applied to output torque of the present engine may be determined S14 based on the results determined in steps S131, S132, S133, and S134.

For example, when the output unit 25 performing the logic AND operation as illustrated in FIG. 3 is disposed in the torque correction determination unit 20, the output unit 25 may determine application of the torque correction value and may output the result in the case that the conditions of steps S131, S132, S133, and S134 in step S14 are satisfied. The switching unit 30 may output the torque correction value generated at the torque correction generator 10 according to the output of the output unit 25. The summing unit 40 may apply the torque correction value output at the switching unit 30 to output torque of the present engine to determine final engine output torque, thereby performing correction of engine output torque S14.

On the contrary, in step S14, when at least one condition of steps S131, S132, S133, and S134 is not satisfied, the output unit 25 may determine not to apply the torque correction value and may output the result. The switching unit 30 may output zero (0) according to the output of the output unit 25. The summing unit 40 may apply zero output at the switching unit 30 to engine output torque not to perform correction of engine output torque S14.

As described above, in the system for correcting engine torque and the method of correcting engine torque according to embodiments of the present disclosure, considering the various states of the vehicle, the engine torque correction value is applied upon change in engine intake density such that decrease in the engine efficiency due to unnecessary correction may be prevented. Thus, efficiency of the vehicle may be considerably improved in comparison with conventional methods of correcting engine torque.

As is apparent from the above description, considering the various driving states such as the state of charge of the main battery of the vehicle, output torque and revolutions-per-minute of the present engine, and part-load maximum torque of the present engine, the engine torque correction value is applied upon change in engine intake density. Thereby, decrease in engine efficiency due to unnecessary correction may be prevented and fuel efficiency of the vehicle may be considerably improved.

Although embodiments of the present disclosure have been described above with reference to the accompanying drawings, those skilled in the art will appreciate that the present disclosure can be implemented with various modifications without changing the technical ideas or features thereof.

What is claimed is:

1. A system for correcting engine torque comprising:
a torque correction value generator generating a torque correction value for correcting output torque of an engine;
a torque correction determination unit determining applicability of the generated torque correction value; and
a torque applying unit determining a final engine output torque by applying the generated torque correction value to the output torque of the engine based on the determined applicability of the generated torque correction value.

2. The system for correcting engine torque according to claim 1, wherein the torque correction value generator comprises:
an intake density determination unit determining a factor related to intake density of the engine based on atmospheric pressure and intake temperature; and
a torque correction map storing a torque correction value based on the factor related to a previous intake density of the engine and a previous state of charge of a main battery, receiving a factor related to a current intake density and a current state of charge of the main battery, and outputting the torque correction value.

3. The system for correcting engine torque according to claim 2, wherein the factor related to intake density includes an atmospheric pressure-intake temperature correction factor (AmpTia factor) which is used as an environmental factor in an engine management system (EMS).

4. The system for correcting engine torque according to claim 1, wherein the torque correction determination unit determines whether the torque correction value is applied to the output torque of the engine based on at least one of the output torque of the present engine, revolutions-per-minute of the engine, a state of charge of a main battery, and part-load maximum torque of the engine.

5. The system for correcting engine torque according to claim 1, wherein the torque correction determination unit comprises a state of charge determination unit receiving a state of charge of a main battery, comparing the state of charge of the main battery with a predetermined reference value, and applying the torque correction value when the state of charge of the main battery is greater than the predetermined reference value.

6. The system for correcting engine torque according to claim 1, wherein the torque correction determination unit comprises a torque determination unit comparing the output torque of the engine with a predetermined reference value and applying the torque correction value when the output torque of the engine is greater than the predetermined reference value.

7. The system for correcting engine torque according to claim 1, wherein the torque correction determination unit comprises an engine revolutions-per-minute determination unit comparing current revolutions-per-minute of the engine with a predetermined reference range and applying the torque correction value when the current revolutions-per-minute of the engine is within a predetermined reference range.

8. The system for correcting engine torque according to claim 1, wherein the torque correction determination unit comprises a torque comparison unit comparing the output torque of the engine with part-load maximum torque and applying the torque correction value when a difference between the output torque of the engine and part-load maximum torque is less than a predetermined reference value.

9. The system for correcting engine torque according to claim 1, wherein the torque applying unit comprises:
a switching unit selectively outputting the generated torque correction value when the torque applying unit applies the torque correction value and selectively outputting zero when the torque applying unit does not apply the torque correction value; and
a summing unit determining the final engine output torque by applying a value output at the switching unit to the output torque of the engine.

10. A method of correcting engine torque comprising:
determining, by a controller, whether a driving environment of a vehicle necessitates torque correction;
generating, by the controller, a torque correction value for correcting output torque of an engine when the driving environment necessitates torque correction;
determining, by the controller, applicability of the generated torque correction value; and
determining, by the controller, final engine output torque by applying the generated torque correction value to the output torque of the engine based on the determined applicability of the generated torque correction value.

11. The method of correcting engine torque according to claim 10, wherein the determining of whether the driving environment necessitates torque correction comprises determining that the driving environment necessitates torque correction when an atmospheric pressure-intake temperature correction factor (AmpTia factor), which is used as an environmental factor in an engine management system (EMS), is greater than a predetermined reference value.

12. The method of correcting engine torque according to claim 10, further comprising applying the torque correction value when a state of charge of a main battery is greater than a predetermined reference value.

13. The method of correcting engine torque according to claim 10, further comprising applying the torque correction value when the output torque of the engine is greater than a predetermined reference value.

14. The method of correcting engine torque according to claim 10, further comprising applying the torque correction value when a revolutions-per-minute of the engine is within a predetermined reference range.

15. The method of correcting engine torque according to claim 10, further comprising:
comparing the output torque of the engine with a part-load maximum torque; and
applying the torque correction value when a difference between the output torque of the engine and the part-load maximum torque is less than a predetermined reference value.
